(19) United States
(12) Patent Application Publication
(10) Pub. No.: US 2015/0277155 A1
(43) Pub. Date: Oct. 1, 2015

(54) CUSTOMIZED EYEWEAR

(71) Applicant: New Eye London Ltd., Holon (IL)

(72) Inventor: Assaf RAVIV, Ramat-Efal (IL)

(73) Assignee: New Eye London Ltd., Holon (IL)

(21) Appl. No.: 14/230,000

(22) Filed: Mar. 31, 2014

(51) Int. Cl. G02C 13/00; B29C 67/00

(52) U.S. Cl. CPC G02C 13/005; B29C 67/0055; B33Y 10/00

(57) ABSTRACT

A method for providing an eyewear product that is customized for a wearer includes obtaining a measured distance that is related to a feature of the wearer's face. A three-dimensional printer is operated to print the eyewear product. The eyewear product is characterized by a dimension that corresponds to the obtained measured distance.

### FIELD OF THE INVENTION

The present invention relates to eyewear. More particularly, the present invention relates to production of a customized eyewear product.

### BACKGROUND OF THE INVENTION

People are distinguishable from one another by their faces. Such distinguishability results from noticeable variability in facial features. Relative placement, shape, and size of such facial features as eyes, nose, and ears vary significantly among individuals.

When purchasing an eyeglass frame, one is often limited to a selection that is available at the point of purchase. An eyeglass wearer or customer may select a frame based on style or other considerations. Features that may play a part in frame selection may include color, size of the lens openings, relative dimensions of the rim and arms, material, durability, weight, or other features.

Once a style has been selected, a frame in that style must be selected whose dimensions are suitable to the wearer's face. Sometimes, a particular style of frame in a particular size may fit one feature of the wearer's face, but not another. In some cases, the lens is to be held at a particular angle to the wearer's line of sight. Thus, selection of an eyeglass frame is often the result of a certain amount of compromise. In order to fit an eyeglass frame to a wearer's face, an eyewear professional (e.g., optician, optometrist, or technician) may sometimes find it necessary bend or otherwise modify the shape or configuration of elements of the frame. Some elements of the frame may be modified by addition of pads or by other structure additions in order to make an existing eyeglass frame fit the wearer's face.

Occasionally, an eyeglass frame must be replaced. For example, a temple or bridge of an eyeglass frame may break. When replacing parts, a vendor may have to compromise between a frame into which the existing lenses fit, a style that is acceptable to the owner of the eyeglasses, and one that fits the owner. In some cases, a structure of the eyeglass frame must be modified in order to securely hold the lenses.

### SUMMARY OF THE INVENTION

There is thus provided, in accordance with some embodiments of the present invention, a method for providing an eyewear product that is customized for a wearer, the method including: obtaining a measured distance that is related to a feature of the wearer's face; and operating a three-dimensional printer to print the eyewear product, the eyewear product being characterized by a dimension that corresponds to the obtained measured distance.

Furthermore, in accordance with some embodiments of the present invention, obtaining the measured distance includes receiving a result of scanning the face.

Furthermore, in accordance with some embodiments of the present invention, receiving the result includes operating a scanner to scan the face.

Furthermore, in accordance with some embodiments of the present invention, the method further includes obtaining a selection of a type of the eyewear product.

Furthermore, in accordance with some embodiments of the present invention, the type includes a style or a color.

Furthermore, in accordance with some embodiments of the present invention, obtaining the selection includes providing a user interface to enable the selection.

Furthermore, in accordance with some embodiments of the present invention, the method further includes calculating the dimension using the obtained measured distance.

Furthermore, in accordance with some embodiments of the present invention, the eyewear includes an eyeglass frame or a component of an eyeglass frame.

Furthermore, in accordance with some embodiments of the present invention, the method further includes delivering the printed eyewear product.

Furthermore, in accordance with some embodiments of the present invention, the measured distance is selected from a group of measured distances consisting of a width of a nose, a length of a nose, a height of a nose, a width of a face, a distance between eyes, and a distance of an eye from a side of a face.

Furthermore, in accordance with some embodiments of the present invention, the dimension is selected from a group of dimensions consisting of a length of a shaft of an eyeglass temple, a distance between eyeglass temples, distance of a lens from an eyeglass temple, and a length of a nose bridge.

There is further provided, in accordance with some embodiments of the present invention, a system for providing an eyewear product that is customized for a wearer, the system including: a three-dimensional printer; and a processor in communication with a computer readable medium, wherein the computer readable medium contains a set of instructions wherein the processor is designed to carry out the set of instructions to: obtain a measured distance related to a feature of the wearer's face; and operate the three-dimensional printer to print the eyewear product, the eyewear product being characterized by a dimension that corresponds to the obtained measured distance.

Furthermore, in accordance with some embodiments of the present invention, the system includes a scanner.

Furthermore, in accordance with some embodiments of the present invention, the set of instructions further includes instructions to operate the scanner to scan the wearer's face.

Furthermore, in accordance with some embodiments of the present invention, the scanner includes a camera of a smartphone.

Furthermore, in accordance with some embodiments of the present invention, the set of instructions further includes instructions to obtain a selection of a type of the eyewear product.

Furthermore, in accordance with some embodiments of the present invention, the type includes a style or a color.

Furthermore, in accordance with some embodiments of the present invention, the set of instructions further includes instructions to calculate the dimension using the obtained measured distance.

Furthermore, in accordance with some embodiments of the present invention, the eyewear product includes an eyeglass frame or a component of an eyeglass frame.

There is further provided, in accordance with some embodiments of the present invention, a method for providing an eyewear product that is customized for a wearer, the method including: obtaining a measured distance that is related to a feature of the wearer's face; and delivering instructions for operating a three-dimensional printer to print the eyewear product, the eyewear product being characterized by a dimension that corresponds to the obtained measured distance.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically shows a system for making a customized eyewear product, in accordance with an embodiment of the present invention.

FIG. 2 is a flowchart depicting a method for producing customized eyewear, in accordance with an embodiment of the current invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In accordance with some embodiments of the present invention, a system for making customized eyewear utilizes three-dimensional (3D) printing technology to manufacture or produce a customized eyewear product. As used herein, a customized eyewear product may refer to customized eyeglasses, a customized eyeglass frame, or a customized part of an eyeglass frame. For example, one or more components of an eyeglass frame, such as a front or temple of the eyeglass frame, may be created by 3D printing. The components may then be assembled with other printed parts, or with parts that were produced in other ways, into an eyeglass frame. Lenses may be inserted into rims of the eyeglass frame. In some applications (e.g., a rigid frame with un-jointed, fixed temples), or with sophisticated 3D printing technology, the entire eyeglass frame may be created as a single unit by 3D printing. (If the 3D printing is also configured to produce lenses, an entire eyeglass may be produced using 3D printing.)

The printed eyewear product or eyeglass frame may be based on a type (e.g., style or color) that is selected by, for, or in cooperation with, an eyeglass wearer. As used herein, “eyeglass wearer” refers to the person (or in some cases, an animal, or an object or device such as a manikin or robot) onto whom the customized eyewear is to be fitted. For example, the eyeglass wearer may require or request an eyeglass frame for new eyeglasses, or may be seeking a replacement frame into which existing eyeglass lenses may be inserted. Internal dimensions of the rims of the eyeglass frame may be selected to fit a particular lens. The rims may be selected to fit either an existing lens, or a lens that was selected by the wearer or eyewear professional (e.g., an optician, optometrist, ophthalmologist, or technician) in accordance with various esthetic or functional considerations.

The customized eyewear product is characterized by one or more dimensions. Dimensions characterizing the eyewear product are determined, calculated, or selected to fit features of the face or head of the eyeglass wearer. The characterizing dimensions may be derived from automatic or manual measurements that are made on the eyeglass wearer's face or head. As used herein, the eyeglass wearer's face is to be understood as including any part of the eyeglass wearer's head whose size is relevant to fitting of eyewear. As used herein, a feature refers to any distinguishable point or structure of the face.

A system for making customized eyewear may incorporate, or may be in communication with, a device that utilizes one or more three-dimensional distance measurement technologies. For example, distances or dimensions of the eyeglass wearer's face may be automatically measured by scanning or by otherwise automatically or manually measuring the eyeglass wearer's face. As used herein, a measured distance of the eyeglass wearer's face may refer to a measured distance between two distinct facial features, or to a measured dimension or size of a single feature (e.g., a distance from one point on a single facial feature to another).

For example, images of the eyeglass wearer's face from that are acquired from two or more different viewpoints (e.g., locations and angles) may be automatically analyzed to yield one or more measurements. The measurements may include linear or curvilinear distances between predetermined points on the eyeglass wearer's face. Alternatively or in addition, the acquired images may be analyzed to yield a three-dimensional model of the eyeglass wearer's face. Distance measurements may be derived from analysis of the model. The resulting measurements may be analyzed to yield required dimensions of a customized eyewear product of a selected type in order to ensure that the customized eyewear product fits the eyeglass wearer's face.

Images of the eyeglass wearer's face may be acquired using a digital camera. In particular, images may be acquired using a camera of a smartphone or cellular phone. For example, a smartphone application may be provided that enables a user to select a type (e.g., style, color) of eyeglass frame, photograph or scan the eyeglass wearer's face, enter an eyeglass prescription (where appropriate) and other information (e.g., related to delivery or payment). The completed eyeglasses may then be produced and shipped to a designated deliver point (e.g., to an address of the eyeglass wearer, to a point of sale, or to another location).

Various scanning or range-finding technologies may be applied to determine a topology of the eyeglass wearer's face. For example, various laser scanning technologies may be applied. Various distance measurement devices (e.g., based on optical, sonic, ultrasonic, electromagnetic, mechanical, or electromechanical distance-measuring methods or techniques) may be scanned over the eyeglass wearer's face to determine a topology of the face. The resulting topology may be analyzed to yield required dimensions of an eyeglass frame of a selected style in order to fit the eyeglass wearer's face.

Alternatively or in addition to automatic scanning, manual measurements may be made on the eyeglass wearer's face. For example, a system for making customized eyewear products may enable (e.g., may include a user interface to enable) entering measurements between predefined points on the face of the eyeglass wearer. For example, the measurements may be made by an eyewear professional. Alternatively or in addition, the system may provide instructions (e.g., via a user interface) that enable a non-professional to make and enter the measurements.

Measured distances or dimensions of the eyeglass wearer's face may include, for example, a width, length, height, or other shape shape-characterizing parameter of a nose, a length, width, or other shape-characterizing parameter (e.g., eccentricity) of a face, a distance between eyes, distance of eye from side of face or ear, or other characterizing measureable distances or dimensions. Relative sizes of such dimensions may differ greatly among individuals, and in particular, in some cases, when comparing among populations with varied ethnic or geographic origins.

A system for making a customized eyewear product may include a capability to convert measurements of an eyeglass wearer's face to required dimensions of one or more components or parts of a customized eyewear product. For example, a formula, algorithm, or conversion factor may be applied to one or more measured distances on the eyeglass wearer's face to yield a dimension of the eyewear product. Such eyewear product dimensions may include, for example, the length of a shaft of an eyeglass temple, distance (width of front) between temples, distance of a lens or rim from the temple, length of nose bridge, or other dimensions of the eyewear product.

The system further includes a capability to control operation of a 3D printer on the basis of the required dimensions of the customized eyewear product. As a result, the 3D printer may be controlled to form a customized eyewear product that fits the eyeglass wearer's face.

Dimensions of a customized eyewear product that may be determined in accordance with measurements of the eyeglass wearer's face may include, for example, the length of a shaft of an eyeglass temple, distance between temples, distance of a lens or rim from the temple, length of a nose bridge, or other dimensions of the eyewear product. Dimensions may be adapted to different styles of eyewear products (e.g., round or rectangular lenses, or other stylistic differences).

An eyewear product may be otherwise customized. For example, user-selectable images or text the may be printed or engraved on one or more parts of the printed eyewear product. Such a text or image may provide information to enable a finder to return the eyewear product to the eyeglass wearer (e.g., name, map, address, or telephone number), may include a message (e.g., identifying the eyewear product as a gift, a favorite quote, or other message), a logo (e.g., of a company or sports team), or other text or image.

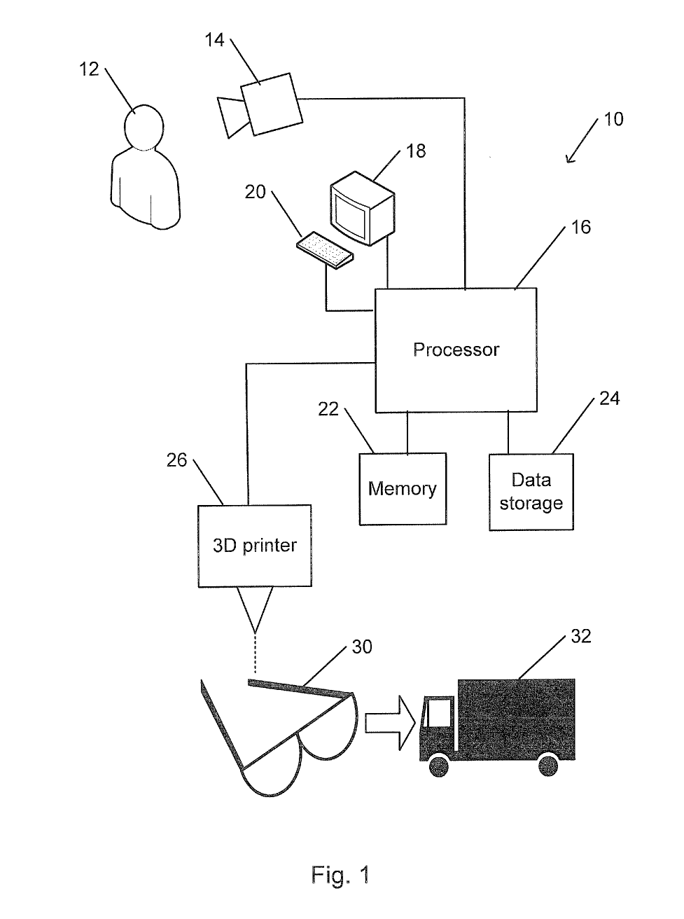

FIG. 1 schematically shows a system for making a customized eyewear product, in accordance with an embodiment of the present invention.

Customized eyewear production system 10 is configured to produce customized eyewear product 30 that is customized to fit eyeglass wearer 12. Customized eyewear product 30 may include an entire eyeglass frame, or one or more components of an eyeglass frame. Customized eyewear product 30 may include lenses, or other parts or accessories in addition to a basic eyeglass frame.

3D printer 26 may be operated to produce customized eyewear product 30. Operation of 3D printer 30 is controlled by processor 16. Processor 16 may control operation of 3D printer 26 to produce customized eyewear product 30 of a predetermined material, color, texture, and size.

Scanner 14 may be operated to obtain distance measurements on the face of eyeglass wearer 12. Operation of scanner 14 may be controlled by processor 16. Measurements obtained by scanner 14 may be interpreted, analyzed, or otherwise processed by processor 16. For example, measurements obtained by scanner 14 may be interpreted to yield distances of, or otherwise characterize, features of the face of eyeglass wearer 12. Measurements obtained by scanner 14 may be stored in memory 22 or on data storage device 24. The measurements may be stored in unprocessed or partially processed form (e.g., prior to interpretation, or at an intermediate stage during interpretation), or results of processing the measurements (e.g., one or more distances related to features of eyeglass wearer 12) may be stored.

For example, scanner 14 may include an imaging device that acquires images of eyeglass wearer 12. A plurality of images may be acquired from a corresponding plurality of directions (e.g., relative to the face of eyeglass wearer 12). Processor 16 may control image acquisition of scanner 14, may control a position of scanner 14 relative to eyeglass wearer 12, or may process the acquired images. For example, processing the acquired images may yield one or more distances related to features of the face of eyeglass wearer 12. As another example, processing the acquired images may yield a three-dimensional representation or model of the face of eyeglass wearer 12. The model may be analyzed to yield one or more distances related to features of the face of eyeglass wearer 12.

Scanner 14 may include a camera of a smartphone or other mobile phone.

As another example, scanner 14 may utilize any other three-dimensional scanning technology that is suitable for application on a face of eyeglass wearer 12. Scanner 14 may utilize one or more of a mechanical, optical, acoustic, electromagnetic, or other technology to yield measurements that may be analyzed to yield one or more distances related to features of the face of eyeglass wearer 12. For example, measurement by scanner 14 may based on distance measurements (e.g., time of flight measurements), on an effect on an appropriate field (e.g., phase shifts or wave interference), analysis of reflection, reflection, or scattering of waves (e.g., light), or another three-dimensional scanning technique.

Processor 16 represents one or more data processing units (e.g., computers, smartphones, or processing units of other devices) with capability to operate in accordance with programmed instructions. Programmed instructions may be stored, e.g., in memory 22 or data storage device 24. Various processing units of processor 16 may be included or incorporated within a single housing (e.g., a single device), or may be physically separated from one another. Various processing units of processor 16 may have identical, similar, or overlapping functionality, or may have different functionality. For example, different processing units may perform different operations of a method or process for producing a customized eyewear product. Functionality of processor 16 may be divided among geographically separated data processing units that are configured to intercommunicate via a network or another connection. For example, geographically separated processing units may include a processing unit that is associated with a scanning device 14, a processing unit that is associated with eyeglass wearer 12 (e.g., a home computer or self-service point of sale), a processing unit that is associated with an eyewear professional, a remote server (e.g., a server associated with a customized eyewear service, manufacturer, or provider, the server being accessible via a network), or a processing unit that is associated with (or a controller of) 3D printer 26.

Processor 16 may communicate with memory 22. Memory 22 may include one or more volatile or nonvolatile memory devices. Memory 22 may be utilized to store, for example, programmed instructions for operation of processor 16, data or parameters for use by processor 16 during operation, or results of operation of processor 16.

Processor 16 may communicate with input device 22. For example, input device 22 may include one or more of a keyboard, keypad, touch screen, pointing device, imaging device, microphone, for enabling a user to inputting data or instructions for operation of processor 16. For example, input device 22 may be operated to indicate a preference or requirement with regard to customized eyewear product 30 (e.g., style, color, or dimension). Input device 22 may be operated to indicate a parameter, preference, or requirement with regard to production of customized eyewear product 30 (e.g., preferred or actual time and place of delivery of customized eyewear product 30, or preferred or actual price for producing customized eyewear product 30).

Processor 16 may communicate with output device 18. For example, output device 18 may include a monitor, display screen, display panel, speaker, printer, or other device for outputting information to an operator of, or person interacting with, processor 16. For example, processor 16 may communicate with output device 18 to convey instructions to a user of customized eyewear production system 10 (e.g., eyeglass wearer 12, an eyewear professional, an operator of 3D printer 26, or another person involved with production of customized eyewear product 30), indicate (e.g., provide feedback regarding) a selected option with regard to production of customized eyewear product 30, or to indicate progress in an operation that is related to production of customized eyewear product 30. Output device 18 may be operated to display a selection (e.g., in the form of an interactive catalog or otherwise) of types, styles, colors, customization options, or other user-selectable options.

Processor 16 may communicate with data storage device 24. Data storage device 24 may include one or more fixed or removable nonvolatile data storage devices. For example, data storage device 24 may include a computer readable medium for storing program instructions for operation of processor 16. For example, the programmed instructions may include instructions to execute operations or component modules of a method for customized eyewear production. It is noted that storage device 24 may be remote from processor 16. In such cases storage device 24 may be a storage device of a remote server storing the programmed instruction in the form of an installation package or packages that can be downloaded and installed for execution by processor 16. Data storage device 24 may be utilized to store data or parameters for use by processor 16 during operation, or results of operation of processor 16.

Data storage device 24 may be utilized to store a database of eyeglass wearers 12. The database may include one or more of identifying data with regard to each eyeglass wearer 12, results of operation of scanner 14, data for operation of 3D printer 26, delivery data, or other data. For example, data retrieved from the database may enable rapid replacement of a lost or broken customized eyewear product 30. Data stored in the database may be retrieved to maintain contact with eyeglass wearers 12 (or their representatives or associates), for promotional purposes (e.g., offering a promotion related to a birthday or holiday that is celebrated by eyeglass wearer 12), or for other purposes.

Components of customized eyewear production system 10 may be included in a single unit, housing, or station. A single unit may include both scanner 14 and 3D printer 26. For example, the single unit may be located for access by an eyewear professional. The single unit may be operated to both measure features of eyeglass wearer 12 and to produce customized eyewear product 30. A single unit may include components that are situated in separate housings but are configured to be placed in close proximity to one another. Such close placement may enable intercommunication via data or power cable, or via a short-range wireless connection.

Components of customized eyewear production system 10 may be included in a two or more separate units, housings, or stations. For example, scanner 14 may be included in one unit, and 3D printer 26 may be included in another, geographically separated, unit. For example, a unit that includes scanner 14 may be located for access by an eyewear professional. The single unit may be operated by, or under supervision of, the eyewear professional to ensure an accurate measurement of features of eyeglass wearer 12. As another example, scanner 14 may be included in a unit or station that is designed for convenient access by eyeglass wearer 12. The results of the scan may be transmitted via a network to a processing unit at another location (e.g., a processing unit that is associated with an eyewear profession or with a server of a customized eyewear production service, or with a production facility that operates 3D printer 26), or may be transferred to a removable or portable computer readable data storage medium that may be physically transported to an operator of another processing unit.

3D printer 26 may be accessible for operation by an eyewear manufacturer or by a customized eyewear production service. In other cases, 3D printer 26 may be operated by a 3D printing facility that offers 3D printing services to the public (e.g., operated by a manufacturer or provider of 3D printer 26, an independent operator, by an operator of a store or point of sale, or by another party). Measurements obtained by scanner 14 may be transmitted by a network to the unit that includes 3D printer 26, may be conveyed via a portable data storage medium to the unit that includes 3D printer 26, or may be conveyed orally or in writing to an operator of a unit that includes 3D printer 26. The unit that includes 3D printer 26 may be operated to produce customized eyewear product 30.

The produced customized eyewear product 30 may be delivered via a delivery unit 32 (e.g., delivery, postal, or messenger service). Customized eyewear product 30 may be delivered to a location of a unit that includes scanner 14 (e.g., to an eyewear professional or point of sale), e.g., for final fitting or checking, or directly to eyeglass wearer 12 (e.g., to a personal delivery address).

In some cases, 3D printer 26 may be operated by (e.g., belong of or be accessible to) eyeglass wearer 12, or by a representative or associate of eyeglass wearer 12. In such a case of self-printing, processor 16 may send or transmit instructions (e.g., in the form of a file) for operation of 3D printer 26 to produce customized eyewear product 30. In such a case, a party who orders customized eyewear product 30 may be charged for sending or transmission of the instructions, and not for delivery of the finished product (customized eyewear product 30). In such a case of self-printing, a delivery unit 32 that is separate from 3D printer 26 may be unnecessary.

Processor 16 may be operated to execute a method for producing customized eyewear, in accordance with an embodiment of the present invention.

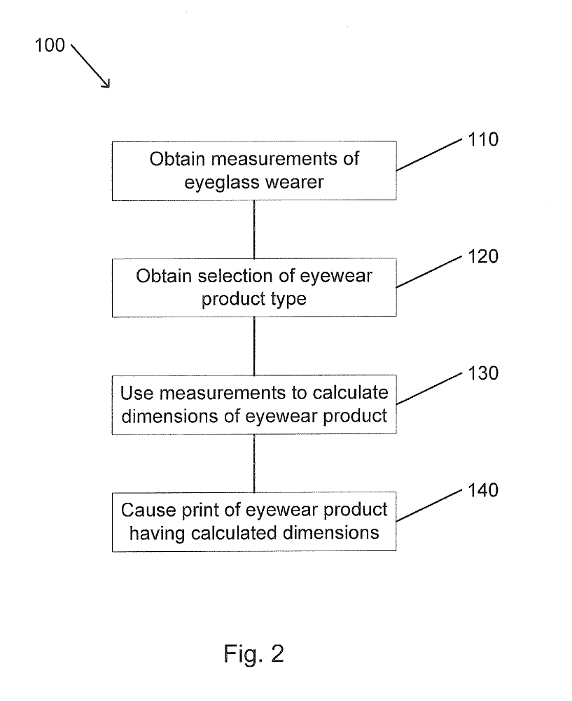

FIG. 2 is a flowchart depicting a method for producing customized eyewear, in accordance with an embodiment of the current invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Customized eyewear production method 100 may be executed by a processor, e.g., of a system for customized eyewear production. For example, various operations of customized eyewear production method 100 may be executed by one or more of a processing unit that is associated with a scanner, a processor that is associated with a 3D printer, by a server of a customized eyewear service or vendor, a processor of a customized eyewear unit or station, a processor associated with an eyewear professional, or by another processor.

Execution of customized eyewear production method 100 may be initiated upon indication that customized eyewear is to be produced. For example, such an indication may originate with an eyeglass wearer, or with an eyewear professional. The indication may be generated by operation of a physical or virtual (e.g., of a displayed graphic interface) control or other input device, e.g., by selecting or operating an appropriate screen control of a graphic user interface or other user interface.

Measurements of the eyeglass wearer's face are obtained (block 110). For example, measurements of distances related to features of the eyeglass wearer's face may be obtained. Relevant feature distance measurements may include, for example, those feature measurements that are relevant to supporting an eyeglass frame on the eyeglass wearer's face (e.g., width of nose, front-back distance of ears from plane of nose, width of ears), those features around which the eyeglass frame is to fit (e.g., a distance between temples), and the location of the eyeglass wearer's eyes relative to other features of the face (e.g., from nose or temples).

The measurements may be obtained automatically, or semi-automatically, by an appropriate measuring device. For example, such a measuring device may include a scanner. The eyeglass wearer's face may be positioned in a predetermined manner (e.g., position and orientation) relative to the scanner. Alternatively or in addition, the scanner may automatically sense the eyeglass wearer's face (e.g., when the face is located within a predetermined region of space). The scanner may operate fully automatically, or cooperation of an operator or of the eyeglass wearer may be required (e.g., to move or rotate the scanner or the eyeglass wearer's face). In some cases, scanning may yield a digital representation of a model of the eyeglass wearer's face. Measurements may be derived for the model or may be measured directly.

Alternatively or in addition, distances related to features of the eyeglass wearer's face may be made measured manually, e.g., using a ruler, caliper, an adjustable eyeglass frame, or other manual measurement device. The measured quantities may be input to a processor that is executing customized eyewear production method 100. For example, a user interface may enable entering of previously measured distances by an operator of the processor or system. The user interface may also prompt the operator to enter a particular measured quantity, or may provide instructions for measurement the quantity. An appropriate measuring device may be provided with an encoder or other device that converts a measured length or distance to an electronic signal that may be directly sensed by the processor (or by an appropriate port or device that is associated with the processor).

Measured distances may be obtained via a network from a remote processing unit, or may be transferred via insertion or connection of a portable data storage medium.

A selection of a desired type of eyewear product is obtained (block 120). The type may include a style of eyeglass frame, of one or more components of an eyeglass frame, a color, or another functional, decorative, or ornamental feature of the desired eyewear product. A user interface may be configured to enable selection of a type of eyeglass frame. The eyeglass wearer, an eyewear professional, or other user may interact with the user interface to indicate the selection.

For example, a catalog or menu, e.g., that is associated with a 3D printer or with a processor that is configured for control operation of the 3D printer, may include a set of types of eyewear products, or features of eyewear products. The set may represent those items that the 3D printer is configured to produce. For example, the set may include an entire eyeglass frame, or an interchangeable or replaceable component of an eyeglass frame (e.g., front or temple). In some cases, dependent of mutual compatibility, various parts of an eyewear product may be selected separately. For example, it may be possible to separately select a shaft and earpiece of a temple of an eyeglass frame, or a rim and bridge of a front of an eyeglass frame. Such separate selection may be possible when the separately selected parts have substantially identical shapes where the separately selected parts meet within the eyewear product.

A style may be selected in accordance with a preference of the eyeglass wearer. The selection of style may be restricted to a subset of the entire set of eyewear styles in accordance with additional requirements. For example, some styles of the set of eyewear styles may not be suitable for a particular eyeglass lens prescription, or to a particular environment (e.g., as related to the eyeglass wearer's occupation, residence, or lifestyle) in which the eyewear product is intended to be worn or stored. The selection may be restricted to a subset of eyewear types as a result of marketing or other business-related considerations.

In the event that a representation of model was constructed as a result scanning the eyeglass wearer's face, a system for producing customized eyewear products may utilize the model to enable selection of a type of eyewear product. For example, a type of eyewear product being considered for selection may be displayed on a rendering of the model.

The obtained measurements and may be used calculate dimensions of the eyewear product to be produced (block 130). An algorithm, formula, or conversion factor may be applied to one or measured dimensions or distances of the eyeglass wearer's face. The result of the application is a dimension of the eyewear product or of a part of the eyewear product. The calculation may also depend on a selected type of eyewear product. For example, different styles of eyeglass frames may be designed to sit differently on the eyeglass wearer's face. Thus, a relation between a dimension of a facial feature and a dimension of the eyewear product may differ for the different styles.

For example, a measured width of the eyeglass wearer's nose may be used to calculate a length of a bridge of a face of an eyeglass frame. Similarly, a measured distance from the eyeglass wearer's ear to the eyeglass wearer's face (e.g., front of the eye) may be used to calculate a length of a shaft of a temple of an eyeglass frame.

The calculated dimensions are utilized to cause printing of a customized eyewear product using a 3D printer (block 140). The customized eyewear product is an eyewear product of the selected type with the dimensions that were calculated using the obtained measurements of the eyeglass wearer's face.

For example, a 3D printer may be controlled to print the customized eyewear product. A processor that controls the 3D printer may be configured (e.g., in accordance with programmed instructions, such as a printer driver program or other program) to control operation of the 3D printer. When controlled, the 3D printer deposits one or more materials in a manner that constructs a selected shape, such as a selected type of eyewear product having particular dimensions. Typically, drops or filaments of the material are deposited in liquid form and are caused to harden (e.g., by a curing process) to form the selected shape. The processor controls deposition of the material and motion of a surface onto which the material is deposited in a coordinated manner such that the selected shape is formed.

A data storage device that is accessible by the processor that controls operation of the 3D printer may contain a computer readable description of the selected type of eyewear product. For example, the description may be written using an appropriate computer-aided design application, or using another method that is configured to write computer-readable instructions for operation of a 3D printer. The description may be parameterized by one or more dimensions. Thus, the processor may issue a series of commands that cause the 3D printer to deposit in a manner to form the selected type of eyewear product having the calculated dimensions.

The printed eyewear product may be delivered to the eyeglass wearer, to an eyewear professional, or to a retailer or point of sale.

As another example, instructions for printing the eyewear product by a 3D printer may be provided directly to the eyeglass wearer or other user or purchaser (e.g., in exchange for payment). For example, the instructions may be delivered in the form of a transmitted 3D printing file. The instructions or a 3D printing file may be otherwise delivered, e.g., in the form of a computer readable medium. The receiver of the instruction may then use the instructions to operate a 3D printer to print one or more copies of the eyewear product.

Production of customized eyewear in accordance with embodiments of the present invention may be advantageous over customary methods of purchasing or providing eyewear. With customary methods, the eyeglass wearer's selection of frames would be limited to stock on hand. Fitting the eyewear to the eyeglass wearer using customary methods would typically involve a certain amount of compromise with regard to dimensions (with an eyewear professional bending or otherwise adjusting an eyeglass frame to fit the wearer's face). A manufacturer who manufactures eyewear using customary methods would typically have to invest in designing, tooling, injection molds, and other equipment. A manufacturer who manufactures eyewear using customary methods would typically have to estimate in advance the demand for each type and size of eyewear, and would risk over- or under-stocking a particular type in a particular size.

On the other hand, production of customized eyewear using 3D printing, in accordance with embodiments of the present invention, requires only construction and maintenance of a computer-readable description. No preparation of dedicated equipment is required, and no stock of eyewear products need be maintained (except, perhaps, a small number of eyewear products for display purposes).

1. A method for providing an eyewear product that is customized for a wearer, the method comprising:
obtaining a measured distance that is related to a feature of the wearer's face; and
operating a three-dimensional printer to print the eyewear product, the eyewear product being characterized by a dimension that corresponds to the obtained measured distance.

2. The method of claim 1, wherein obtaining the measured distance comprises receiving a result of scanning the face.

3. The method of claim 2, wherein receiving the result comprises operating a scanner to scan the face.

4. The method of claim 1, further comprising obtaining a selection of a type of the eyewear product.

5. The method of claim 4, wherein the type comprises a style or a color.

6. The method of claim 4, wherein obtaining the selection comprises providing a user interface to enable the selection.

7. The method of claim 1, further comprising calculating the dimension using the obtained measured distance.

8. The method of claim 1, wherein the eyewear comprises an eyeglass frame or a component of an eyeglass frame.

9. The method of claim 1, further comprising delivering the printed eyewear product.

10. The method of claim 1, wherein the measured distance is selected from a group of measured distances consisting of a width of a nose, a length of a nose, a height of a nose, a width of a face, a distance between eyes, and a distance of an eye from a side of a face.

11. The method of claim 1, wherein the dimension is selected from a group of dimensions consisting of a length of a shaft of an eyeglass temple, a distance between eyeglass temples, distance of a lens from an eyeglass temple, and a length of a nose bridge.

12. A system for providing an eyewear product that is customized for a wearer, the system comprising:
a three-dimensional printer; and
a processor in communication with a computer readable medium, wherein the computer readable medium contains a set of instructions wherein the processor is designed to carry out the set of instructions to:
obtain a measured distance related to a feature of the wearer's face; and
operate the three-dimensional printer to print the eyewear product, the eyewear product being characterized by a dimension that corresponds to the obtained measured distance.

13. The system of claim 12, further comprising a scanner.

14. The system of claim 13, wherein the set of instructions further includes instructions to operate the scanner to scan the wearer's face.

15. The system of claim 13, wherein the scanner comprises a camera of a smartphone.

16. The system of claim 12, wherein the set of instructions further includes instructions to obtain a selection of a type of the eyewear product.

17. The system of claim 16, wherein the type comprises a style or a color.

18. The system of claim 12, wherein the set of instructions further includes instructions to calculate the dimension using the obtained measured distance.

19. The system of claim 12, wherein the eyewear product comprises an eyeglass frame or a component of an eyeglass frame.

20. A method for providing an eyewear product that is customized for a wearer, the method comprising:
obtaining a measured distance that is related to a feature of the wearer's face; and
delivering instructions for operating a three-dimensional printer to print the eyewear product, the eyewear product being characterized by a dimension that corresponds to the obtained measured distance.
